(19) United States
(12) Patent Application Publication
(10) Pub. No.: US 2022/0267032 A1
(43) Pub. Date: Aug. 25, 2022

(54) MODULAR SATELLITE DEPLOYER METHOD, SYSTEM, AND APPARATUS

(71) Applicant: OMNITEQ, LLC, Houston, TX (US)

(72) Inventor: Michael David Johnson, Houston, TX (US)

(21) Appl. No.: 17/493,579

(22) Filed: Oct. 4, 2021

Related U.S. Application Data
(60) Provisional application No. 63/153,502, filed on Feb. 25, 2021.

(51) Int. Cl. B64G 1/64; E05C 19/00

(52) U.S. Cl. CPC B64G 1/641; E05C 19/00; B64G 2001/643

(57) ABSTRACT

The invention discloses a modular satellite deployer system and method utilizing a novel geometric door configuration employing a novel geometry that permits any number or combination of satellites to deploy from a common sized satellite deployer. The satellite deployer system includes an enclosure. The satellite deployer system includes two or more satellites shaped to conform with the inside of the enclosure. The satellite deployer system includes multi segmented doors, door release mechanisms, and multi segmented ejector mechanisms. Each of multi segmented ejector mechanisms is capable of pushing a satellite of the two or more satellites out of the enclosure. Two or more satellites deploy from the enclosure in any desired sequence by selectively opening the multi segmented doors using the multi segmented door release mechanisms and the multi segmented ejector mechanisms.

### CROSS-REFERENCE TO RELATED APPLICATIONS

The present application claims priority from U.S. Provisional Patent Application Ser. No. 63/153,502, filed on Feb. 25, 2021, which is incorporated herein by its entirety and referenced thereto.

### FIELD OF THE DISCLOSURE

This disclosure relates generally to a modular satellite deployer system and method utilizing a novel geometric door configuration employing a novel geometry that permits any number or combination of satellites to deploy from a common sized satellite deployer.

### BACKGROUND OF THE DISCLOSURE

For the purposes of interpreting the disclosure made herein, the terms “CubeSat deployer”, “satellite deployer”, “satellite deployer system”, or derivations thereof are used interchangeably and should be considered synonymous. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Commercial development outside the earth's atmosphere, i.e., outer space, presents physical and logistics challenges and difficulties. The hazards and costs associated with outer space commerce are of a different nature from those within the earth's atmosphere. Because of these challenges and difficulties, satellites have been, and will continue to be a primary means for the clear majority of extra-planetary operations. Satellites have been used to explore space, gather and relay data, perform experiments, and do any other number of tasks.

Picosatellites, including CubeSats, provide a means for minimizing the financial barrier to space entry. The components used to build CubeSats are usually relatively inexpensive, off-the-shelf electronics. The small size of these CubeSats and other picosatellites coupled with their uniform dimensions and inexpensive components make these satellites an attractive means of accessing space at a relatively small cost.

Miniaturized satellites can simplify problems commonly associated with mass production, although few satellites of any size, other than “communications constellations” (where dozens of satellites are used to cover the globe), have been mass-produced in practice. One reason for miniaturizing satellites is to reduce the cost associated with transporting them into space. Heavier satellites require more energy to transport them into orbit or open space, thereby requiring larger rockets with greater fuel requirements, which results in higher costs. In contrast, smaller and lighter satellites require less energy and less volume (requiring smaller and cheaper launch vehicles) and may be launched in multiples, or in other words, deployed in groups and at the same time. These small satellites, such as CubeSats and other picosatellites, can also be launched in a “piggyback” manner, using excess capacity available on already loaded launch vehicles.

The high cost of transporting mass from the surface of a stellar body into an orbit around a celestial body, or open space, has especially limited the development of outer space commercial activity. This high cost per unit mass has made minimizing the mass of the objects being sent into space particularly important. To achieve their purpose, CubeSats must be transported out of the atmosphere and released into space (whether that is into an orbit around a celestial body or into open space). Satellite deployers are used to store and protect satellites during their transportation into space. These satellite deployers protect the payloads stored inside of them from damage caused by the inherent stresses resulting from launching such payloads into space. The satellite deployer must also safely and efficiently deploy their satellite payloads into the correct trajectory once the system has reached space.

California Polytechnic State University (“Cal Poly”) initiated the CubeSat concept in 1999, to enable users to perform space science and exploration at lower costs. A basic CubeSat (“1 U”) is a 10 cm cube (one liter in volume) having a mass of approximately 1.33 kg. Other common sizes are available, including a “2 U” that is 20 cm×10 cm×10 cm, and a “3 U” that is 30 cm×10 cm×10 cm. Other sizes, such as a “6 U” (30 cm×10 cm×20 cm), “12 U” (30 cm×20 cm×20 cm), and “27 U” (30 cm×30 cm×30 cm), have also been proposed, the dimensions cited herein are ‘nominal.’ The standardized specification of CubeSats also allows for the deployment means of these satellites to be standardized as well. The standardization among both payloads and deployers enables quick exchanges of payloads without the need of customized payload-deployer interfaces. It also allows for easily interchanging parts across similarly dimensioned satellites.

Associated with the minimization of mass is the minimization of volume. This is important in the field of space transportation since there is a finite amount of usable storage volume inside of space vehicles. This minimization of mass and volume is important not only for satellites, but for the systems used to store, transport and deploy the satellites.

To deploy a CubeSat in space, a dispensing device is used to ‘push’ the CubeSat away from the delivery spacecraft. This dispensing device is also used to transport the CubeSat and to secure it to the delivery spacecraft. Current dispensing devices include the “P-Pod” (Poly's Pico-satellite Orbital Deployer), designed by Cal Poly, and the ISIPOD deployer, designed by ISIS (Innovative Solutions In Space). The P-Pod deployer accommodates a “3 U” CubeSat, or, equivalently, three “1 U” CubeSats, or, one “1 U” CubeSat and one “2 U” CubeSat”. The ISIPOD is also available in a variety of sizes.

Satellite deployers may be designed as storage containers into which satellites are placed. These container-type satellite deployers usually provide a door at one end, through which payloads may be loaded and unloaded. After loading, the deployer system's door is secured, and the deployer system is then mounted onto a launch vehicle which is responsible for transporting the deployer system, including any satellites or other space payloads stored therein, into space.

CubeSats typically utilize a rail system to hold the CubeSat in the deployer during launch and the rail system is then used as a guide during ejection from the deployer. The traditional CubeSat deployer (e.g. CalPoly or ISIS deployer) uses a four-rail system with a rail at each corner of the deployer (relative to the longitudinal axis of the deployer) to restrain the CubeSat which is required to have a matching rail set that slides along the deployer rails during ejection.

An alternative CubeSat deployer format is the “tab” or flange system of Holemans in U.S. Pat. No. 9,415,883. In this system each CubeSat includes a pair (i.e. two) of opposing flanges on a lower portion of the satellite that ride in a channel formed by the deployer's guide rails and restraining flanges. During travel and launch, the satellite flanges are held against the restraining flanges, rigidly fixing the satellite to the dispenser until the satellite is deployed.

It is well known in prior art that satellite deployers utilize various types of coiled springs to provide separation force between a deployer and a satellite being deployed. These springs are called deployment springs.

The P-POD and similar deployers are designed to carry standard format CubeSats which are stored in the deployer's rectangular outer aluminum or composite box with an electrically released door mechanism. After an electrical signal is sent from a launch vehicle, the front door hold down mechanism is opened and the CubeSat(s) are pushed out by a deployment spring exerting force on a pusher plate which pushes the back of the end CubeSat. The CubeSat(s) slide along guide rails that typically have an aspect ratio (i.e. satellite length to width) that is longer than the width of the satellite. The deployer spring force eventually ejects the CubeSats(s) into orbit with a separation velocity of a few meters per second.

Various hold down mechanisms for deployer doors are well known in the art. For example, shape memory alloy actuated mechanisms and burn wire mechanisms are activated by an electrical current passing through a heating element.

Prior art deployers have a common problem. They are generally designed to accommodate only one format of satellite. For example, a common deployer is termed a “QuadPak” as it can accommodate four 1 U×1 U×3 U CubeSat format satellites in a 2 U× 2 U×3 U enclosure. This same enclosure could also accommodate two 1 U×2 U×3 U (6 U double wide) CubeSats or one 2 U×2 U×3 U (12 U) CubeSat but, unfortunately, the deployers including the rail structure and door mechanisms must be manufactured specifically to the format of satellite to be accommodated and are unable to be reconfigured to accommodate another format of satellite.

The disclosed subject matter helps to avoid these and other problems in a new and novel way.

### SUMMARY OF THE DISCLOSURE

The disclosure relates to a modular satellite deployer system and method utilizing a novel geometric door configuration employing a novel geometry that permits any number or combination of satellites to deploy from a common sized satellite deployer.

According to the teachings of the present disclosure, there is here provided a satellite deployer system that utilizes 1. A receptacle located on the launch vehicle side of the apparatus having a rectangular shape of an extruded box with at least two rails per accommodated satellite located on the inside walls of the box (generally in the inside corners of said box) where the rails can be reconfigured at any time to accommodate any number of satellites, 2. A satellite (or multiple satellites) whose shape generally conforms to the inside of the receptacle and is constrained by said rails, 3. A releasable set of doors that holds satellite(s) in place until the desired deployment time and is able to selectively deploy any number of satellites contained in said receptacle in any desired order and 4. An ejector mechanism that pushes satellite(s) out of the receptacle in a general straight line motion.

The main advantages of using the inventive satellite deployer system is that it provides a modular and reconfigurable launch load support system that off loads the satellite structure while providing the flexibility of accommodating any number of satellites prior to launch of the deployer with minimal changes to the deployer.

The inventive device can utilize a deployer enclosure that can accommodate up to a 12 U format CubeSat satellite. The front of the enclosure is comprised of a set of door flaps on hinges that form the front side of the enclosure. All door flaps are generally triangular and intersect at a common point. All other five sides of the enclosure are generally solid panels that may or may not have openings, either open holes in the panels or doors on the panels, to access the contents inside the enclosure. Hinges for the door flaps may be formed of any hinge system as is well known in the art but a fabric or flex hinge, as is well known in the art, is preferred as it is less likely to bind or seize under the vacuum and thermal conditions of space.

Release of a 12 U satellite, as an example, is accomplished by opening all eight door flaps simultaneously. Release of all door flaps permits a pusher plate behind the satellite to force the satellite to slide along rails thus pushing open the door flaps while the satellite is ejected from the enclosure. The pusher plate is restrained from leaving the enclosure by any well-known means. Additionally, the door flap hinges can utilize a torsion spring or some other method to urge door flaps open in addition to the force of the deploying satellite.

This door geometry has multiple advantages, namely 1. each of the door flaps can open independently of the other door flaps, 2. each door flap is hinged on a single edge which, when combined with all the other door flaps, provides the maximum length of hinge available and thus, maximum strength available to all the door flaps to restrain the satellite inside the enclosure, and 3. All door flaps can be restrained at a common intersection zone.

As mentioned earlier, each of the door flaps can open independently of the other door flaps. For example, where only four of the eight door flaps are required to open to permit a single 6 U CubeSat satellite to be ejected (a 6 U CubeSat is half of a 12 U CubeSat) while a second 6 U CubeSat satellite is still restrained. Later, the remaining closed-door flaps can be opened to release the additional 6 U CubeSat. Two 6 U CubeSat satellites would be typically restrained with an additional set of four rails added to the enclosure along the dividing plane between the two 6 U CubeSat satellites. In addition, a pusher plate is required for each satellite contained in the enclosure.

A further advantage of the door flap geometry is where only two pair of the eight door flaps open to permit a single 3 U CubeSat satellite to be ejected while three other 3 U CubeSat satellites are still restrained. Later, the remaining closed-door flaps can be opened in similar pairs to release the additional 3 U CubeSat satellites. Four 3 U CubeSat satellites are typically restrained with an additional set of twelve rails added to the enclosure along the two dividing planes between the four 3 U CubeSat satellites, one in each quadrant of the enclosure. In addition, a separate pusher plate is required for each satellite contained in the enclosure.

An additional advantage of this door geometry is that a combination of two 3 U CubeSat format satellites and one 6 U CubeSat format satellite can be accommodated where, for example, the 6 U CubeSat format satellite can be released by releasing four door flaps and the two other 3 U CubeSat format satellites can be released by opening adjacent pairs of door flaps in any order desired. Of course, the satellites are restrained using the proper combination of additional rails and a proper amount of pusher plates as needed.

One way to overcome changing out of pusher plates is to simply use four pusher plates with each pusher plate utilizing its own spring, one in each quadrant of the enclosure, that may be tied together with mending plates. In the case of a 12 U CubeSat format satellite, four pusher plates are tied together. In the case of a 6 U CubeSat format satellite, two pusher plates are tied together. In the case of 3 U CubeSat format satellites, only one pusher plate per satellite is used.

The inventive device also permits a novel method of door securing and release mechanism. All door flaps are hinged on one edge and each door flap has a single vertex that converges at a common point. Additionally, all door flaps can be restrained with a common circular element. Force on doors from satellites inside of the enclosure will tend to put this circular element in tension. The circular element can be made of a high strength polymer (e.g. aramid fiber or monofilament line) such that a resistive heating cutting wire (e.g. composed of nichrome wire or similar electrical resistive element) are able to fuse and thus cut through the circular element to release the individual door flaps.

The circular element can be restrained by fasteners (e.g. screws) on posts on each door flap. This permits easy access for changing out the circular element after testing or reloading of the deployer with satellites. A resistive cutting wire element is restrained by electrically conductive posts in each door flap. Each resistive heating cutting wire element is restrained between two electrically conductive posts. These posts can use some form of spring mechanism or be springs themselves to keep resistive heating cutting wire elements in tension against the circular element to urge the resistive heating cutting wire elements through the circular element as they are melting the circular element. Each door flap has two resistive heating cutting wire elements. Since each resistive heating cutting wire elements can be individually heated and cut through the circular element near the edge of each door flap, each door flap may be released in any order desired. An additional advantage of having dual resistive cutting wire elements is that redundant release of each door panel is possible in the event of failure of either or both resistive cutting wire elements on a single door flap in that the two neighboring door flaps are also capable of cutting the circular element near the adjacent edge of each door flap thus releasing the door flap containing the failed resistive cutting wire elements.

The door flaps may be constructed of common printed circuit board material to enable convenient electrical connection of the electrically conductive posts to release control circuitry via, for example, a flexible cable that passes over each door flap hinge.

It should be noted that this door release mechanism is a low shock release device.

Descriptions of certain illustrative aspects are described herein in connection with the figures. These aspects are indicative of various non-limiting ways in which the disclosed subject matter may be utilized, all of which are intended to be within the scope of the disclosed subject matter.

Other advantages, emerging properties, and features will become apparent from the following detailed disclosure when considered in conjunction with the associated figures that are also within the scope of the disclosure.

### BRIEF DESCRIPTION OF THE DRAWINGS

The present subject matter will now be described in detail with reference to the drawings, which are provided as illustrative examples of the subject matter to enable those skilled in the art to practice the subject matter. Notably, the figures and examples are not meant to limit the scope of the present subject matter to a single embodiment, but other embodiments are possible by way of interchange of some or all of the described or illustrated elements and, further, wherein:

FIG. 1 is an isometric view of a closed state of the inventive device;

FIG. 2 is an isometric view of an open state of the inventive device;

FIG. 3 illustrates a second open state of the inventive device;

FIG. 4 illustrates a third open state of the inventive device;

FIG. 5 illustrates the door restraint system of the inventive device; and

FIG. 6 is a closer view of the door restraint system of the inventive device.

### DETAILED DESCRIPTION OF ILLUSTRATIVE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

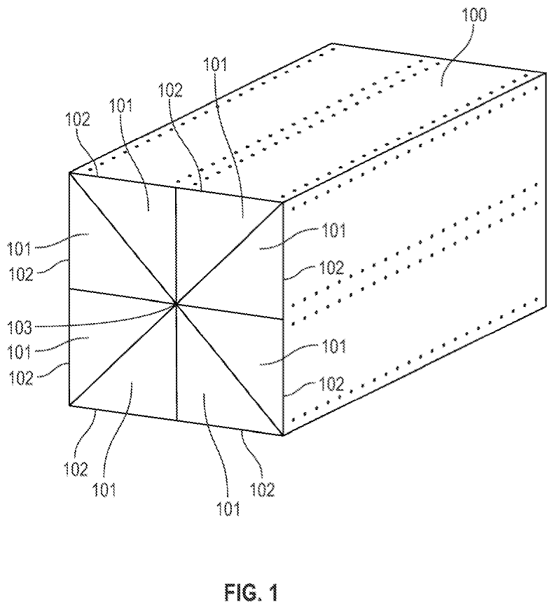

The figures herein provided, in conjunction with the written description here, clearly provide enablement of all claimed aspects of the disclosed subject matter. Accordingly, in FIG. 1 a deployer enclosure 100 that can accommodate up to a 12 U format CubeSat is illustrated. The front of enclosure 100 is comprised of a set of eight door flaps 101 on hinges 102 that form the front side of enclosure 100. All door flaps 101 intersect at the common point 103. All other five sides of enclosure 100 are generally solid panels that may or may not have openings, either open holes in the panels or doors on the panels, to access the contents inside enclosure 100. Hinges 102 may be formed of any hinge system as is well known in the art but a fabric or flex hinge, as is well known in the art, is preferred as it is less likely to bind or seize under the vacuum and thermal conditions of space.

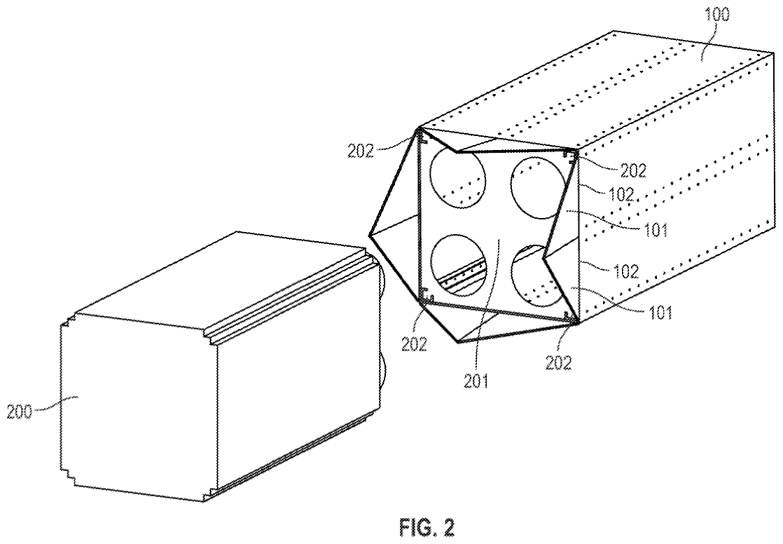

FIG. 2 illustrates the release and deployment of a 12 U format CubeSat satellite 200 from enclosure 100. Release of satellite 200 is accomplished by opening all eight door flaps 101 simultaneously. Release of door flaps 101 permits pusher plate 201 to force satellite 200 (i.e., rail-receiving structures at satellite) to slide along rails 202 thus pushing open door flaps 101 while satellite 200 is ejected from enclosure 100. Pusher plate 201 is restrained from leaving enclosure 100 by any well-known means. Additionally, hinges 102 can utilize a torsion spring or some other method to urge door flaps open in addition to the force of the deploying satellite 200.

This door geometry has multiple advantages, namely 1. each of the door flaps 101 can open independently of the other door flaps 101, 2. each door flap 101 is hinged on a single edge which, when combined with all the other door flaps 101, provides the maximum length of hinge available and thus, maximum strength available to all the door flaps 101 to restrain the satellite 200 inside enclosure 100, and 3. All door flaps 101 can be restrained at the common intersection 103.

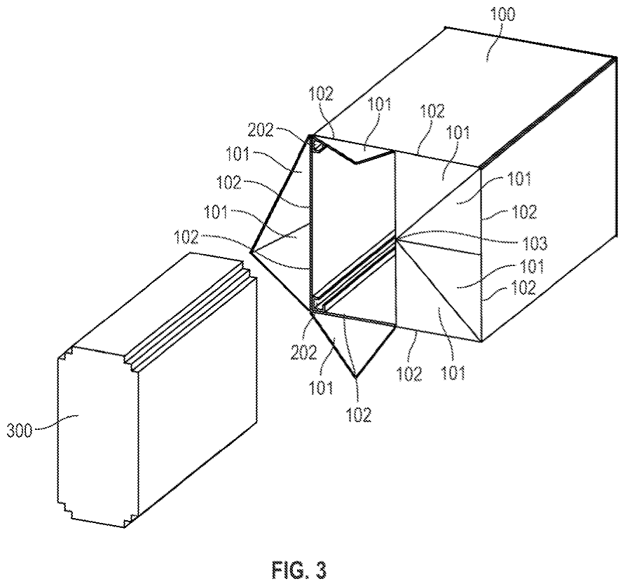

As mentioned earlier, each of the door flaps 101 can open independently of the other door flaps 101. This advantage is illustrated in FIG. 3 where only four of the eight door flaps 101 open to permit a single 6 U CubeSat satellite 300 to be ejected while a second 6 U CubeSat satellite 300 (hidden behind closed door flaps 101) is still restrained. Later, the closed-door flaps 101 can be opened to release the additional hidden 6 U CubeSat 300. The two 6 U CubeSat satellites 300 are typically restrained with an additional set of four rails (hidden behind closed door flaps 101) added to enclosure 100 along the dividing plane between the two 6 U CubeSat satellites 300. In addition, a pusher plate 201 is required for each satellite 300 contained in enclosure 100.

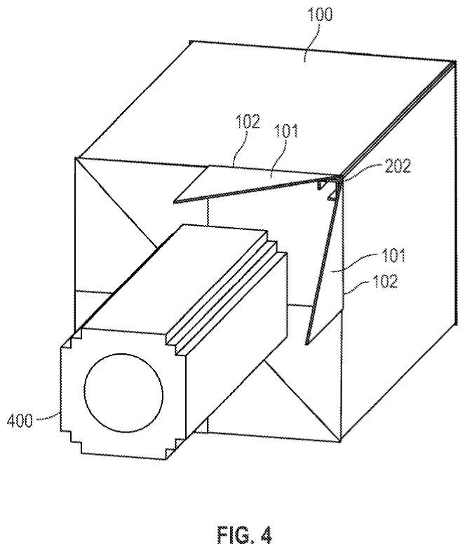

FIG. 4 further illustrates the advantage of the door flap 101 geometry where only two pair of the eight door flaps 101 open to permit a single 3 U CubeSat satellite 400 to be ejected while three other 3 U CubeSat satellites 400 (hidden behind closed door flaps 101) are still restrained. Later, the closed-door flaps 101 can be opened in similar pairs to release the additional hidden 3 U CubeSat satellites 400. The four 3 U CubeSat satellites 300 are typically restrained with an additional set of twelve rails (hidden behind closed door flaps 101) added to enclosure 100 along the two dividing planes between the four 3 U CubeSat satellites 300, one in each quadrant of enclosure 100. In addition, a separate pusher plate 201 is required for each satellite 400 contained in enclosure 100.

An additional advantage of this door geometry is that a combination of two 3 U CubeSat format satellites 400 and one 6 U CubeSat format satellite 300 can be accommodated where, for example, the 6 U CubeSat format satellite 300 can be released as in FIG. 3 and the two other 3 U CubeSat format satellites 400 can be released as in FIG. 4 in any order desired. Of course, the satellites 300 and 400 are restrained using the proper combination of additional rails 202 and a proper amount of pusher plates 201 as needed.

One way to overcome changing out of pusher plates 201 is to simply use four pusher plates 201 with each pusher plate 201 utilizing its own spring, one in each quadrant of the enclosure 100, that may be tied together with mending plates. In the case of a 12 U CubeSat format satellite 200, four pusher plates 201 are tied together. In the case of a 6 U CubeSat format satellite 300, two pusher plates 201 are tied together. In the case of 3 U CubeSat format satellites 300, only one pusher plate 201 per satellite 400 is used.

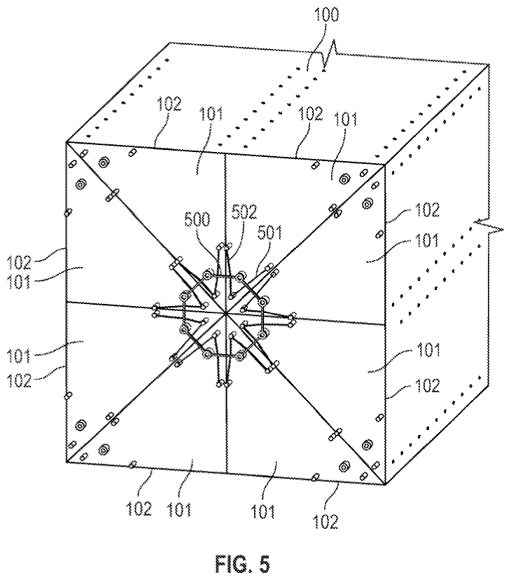

FIG. 5 illustrates a method of door securing and release mechanism. All door flaps 101 (that are hinged on hinges 102) converge at a common point 103. Additionally, all door flaps are restrained with a common circular element 500. Force on doors from satellites inside of enclosure 100 will tend to put circular element 500 in tension. Circular element 500 can be made of a high strength polymer (e.g. aramid fiber or monofilament line) such that resistive heating cutting wire elements 501 and 502 (e.g. composed of nichrome wire or similar electrical resistive element) are able to fuse and thus cut through the circular element 500 to release door flaps 101.

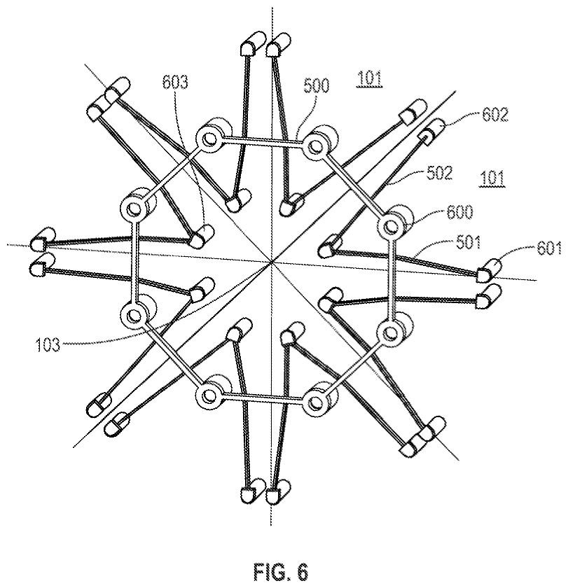

FIG. 6 is a detail view of the release mechanism. Circular element 500 is restrained by fasteners (e.g. screws) on posts 600. This permits easy access for changing out circular element 500 after testing or reloading of the deployer with satellites. Resistive cutting wire element 501 is restrained by electrically conductive posts 601 and 603. Resistive heating cutting wire element 502 is restrained by electrically conductive posts 602 and 603. Posts 601, 602 and 603 can use some form of spring mechanism or be springs themselves to keep resistive heating cutting wire elements 501 and 502 in tension against circular element 500 to urge the resistive heating cutting wire elements 501 and 502 through circular element 500 as they are melting circular element 500. Each door flap 101 has two resistive heating cutting wire elements 501 and 502. Since each resistive heating cutting wire elements 501 and 502 can be individually heated and cut through circular element 500 near the edge of each door flap 101, each door flap 101 may be released in any order desired. An additional advantage of having dual resistive cutting wire elements 501 and 502 is that redundant release of each door panel is possible in the event of failure of either or both resistive cutting wire elements 501 and 502 on a single door flap 101 in that the two neighboring door flaps 101 are also capable of cutting circular element 500 near the adjacent edge of each door flap 101 thus releasing the door flap 101 with failed resistive cutting wire elements 501 and/or 502.

Door flaps 101 may be constructed of common printed circuit board material to enable convenient electrical connection of electrically conductive posts 601 and 603 to release control circuitry via, for example, a flexible cable that passes over hinge 102.

It should be noted that this door release mechanism is a low shock release device.

In summary, here has been shown a satellite deployer system that utilizes 1. A receptacle located on the launch vehicle side of the apparatus having a rectangular shape of an extruded box with at least two rails per accommodated satellite located on the inside walls of the box (generally in the inside corners of said box) where the rails can be reconfigured at any time to accommodate any number of satellites, 2. A satellite (or multiple satellites) whose shape generally conforms to the inside of the receptacle and is constrained by said rails, 3. A releasable set of doors that holds satellite(s) in place until the desired deployment time and is able to selectively deploy any number of satellites contained in said receptacle in any desired order and 4. An ejector mechanism that pushes satellite(s) out of the receptacle in a general straight line motion.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The detailed description set forth here, in connection with the appended drawings, is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

This detailed description of illustrative embodiments includes specific details for providing a thorough understanding of the presently disclosed subject matter. However, it will be apparent to those skilled in the art that the presently disclosed subject matter may be practiced without these specific details. In some instances, well-known structures and devices are shown in block diagram form in order to avoid obscuring the concepts of the presently disclosed method and system.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter.

What is claimed is:

1. A satellite deployer system, comprising:
an enclosure;
a satellite shaped to conform with the inside of said enclosure;
a door connected at a side of said enclosure;
a door release mechanism connected to said door; and
an ejector mechanism that pushes said satellite out of said enclosure,
wherein said satellite deploys from said enclosure by selectively opening said door using said door release mechanism and said ejector mechanism.

2. The satellite deployer system of claim 1, wherein said enclosure has a shape of an extruded cylinder or polygon.

3. The satellite deployer system of claim 1, wherein said door connects to said enclosure via a hinge.

4. The satellite deployer system of claim 1, wherein said enclosure comprises rails.

5. The satellite deployer system of claim 4, wherein said satellite comprises rail-receiving structures, wherein said rails receive said rail-receiving structures, and wherein when said ejector mechanism pushes said satellite forcing said rail-receiving structures to slide along said rails and pushing said door open for deploying said satellite.

6. The satellite deployer system of claim 1, wherein said ejector mechanism comprises a pusher plate.

7. The satellite deployer system of claim 1, wherein said door release mechanism is a low shock release device.

8. A satellite deployer system, comprising:
an enclosure;
two or more satellites shaped to conform with the inside of said enclosure;
multi segmented doors connected at a side of said enclosure;
door release mechanisms, each connecting a door of said multi segmented doors; and
multi segmented ejector mechanisms, each capable of pushing a satellite of said two or more satellites out of said enclosure,
wherein said two or more satellites deploy from said enclosure in any desired sequence by selectively opening said multi segmented doors using said door release mechanisms and said multi segmented ejector mechanisms.

9. The satellite deployer system of claim 8, wherein said enclosure has a shape of an extruded cylinder or polygon.

10. The satellite deployer system of claim 8, wherein said multi segmented doors converge at a common point.

11. The satellite deployer system of claim 8, wherein said multi segmented doors are restrained with a common circular element.

12. The satellite deployer system of claim 11, wherein each of said multi segmented doors comprises resistive cutting wire elements.

13. The satellite deployer system of claim 12, wherein said resistive cutting wire elements are restrained by electrically conductive posts, wherein said electrically conductive posts keep said resistive cutting wire elements in tension against said circular element.

14. The satellite deployer system of claim 13, wherein said resistive cutting wire elements fuse and cut through said circular element to release a door of said multi segmented doors.

15. The satellite deployer system of claim 13, wherein each of said resistive cutting wire elements individually heats up and cuts through said circular element near the edge of a door in order to release said door.

16. The satellite deployer system of claim 8, wherein said enclosure comprises rails.

17. The satellite deployer system of claim 16, wherein each of said two or more satellites comprises rail-receiving structures, wherein said rails receive said rail-receiving structures, and wherein when a multi segmented ejector mechanism of said multi segmented ejector mechanisms pushes a satellite of said two or more satellites forcing said rail-receiving structures to slide along said rails and pushing corresponding door open for deploying said satellite.

18. A method of providing a satellite deployer system, said method comprising the steps of:
providing an enclosure;
providing two or more satellites conforming to the shape of the inside of said enclosure;
providing multi segmented doors connected at a side of said enclosure;
providing door release mechanisms, each connecting a door of multi segmented doors;
providing multi segmented ejector mechanisms, each capable of pushing a satellite of said two or more satellites out of said enclosure;
releasing said two or more satellites in any combination by sequencing said multi segmented door release mechanisms to open said multi segmented doors; and
ejecting said two or more satellites from said receptacle via corresponding ejection mechanism of multi segmented ejector mechanisms.

19. The method of claim 18, further comprising:
providing a common circular element for restraining said multi segmented doors;
providing resistive cutting wire elements at each door of said multi segmented doors; and
providing electrically conductive posts for restraining said resistive cutting wire elements, said electrically conductive posts keeping said resistive cutting wire elements in tension against said circular element.

20. The method of claim 19, further comprising fusing said resistive cutting wire elements for cutting through said circular element to release a door of said multi segmented doors.
